(19) United States
(12) Patent Application Publication
(10) Pub. No.: US 2012/0319481 A1
(43) Pub. Date: Dec. 20, 2012

(54) DOUBLE DISPLAY DEVICE

(75) Inventor: WEI-DONG CONG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD ., Shenzhen City (CN)

(21) Appl. No.: 13/216,268

(22) Filed: Aug. 24, 2011

(30) Foreign Application Priority Data
Jun. 15, 2011 (CN) 201110159797.6

(51) Int. Cl. H02J 4/00

(52) U.S. Cl. 307/39

(57) ABSTRACT

A double display device includes a first display and a second display. The first and the second displays cooperatively show an interface. The double display device further includes a double display module, a detection module, a determination module, a single display module. The double display module activates the first and the second displays to show the interface. The detection module detects the level of the electrical charge of the double display device. The determination module determines whether the level of electrical charge of the double display device is less than or equal to a predetermined value. The single display module turns off one of the first and the second displays, and displays the interface on the other of the first and the second displays, when the level of the electrical charges of the double display device is less than or equal to the predetermined value.

### BACKGROUND

1. Technical Field

The present disclosure relates to a double display device.

2. Description of Related Art

A double display device e.g., double display cell phones, consume more electrical energy than a single display device because double display device uses two displays and not one. Consumers sometimes would like to extend the standby time of the double display device when the electrical charge in the battery of the double display device is low.

Therefore, it is desirable to provide a double display device, which can overcome the above-mentioned limitations.

### BRIEF DESCRIPTION OF THE DRAWINGS

FIG. 1 is a plan schematic view of a double display device according to an embodiment.

FIG. 2 is a functional block diagram of the double display device of FIG. 1.

FIG. 3 is a flow chart of a control method of the double display device of FIG. 1.

### DETAILED DESCRIPTION

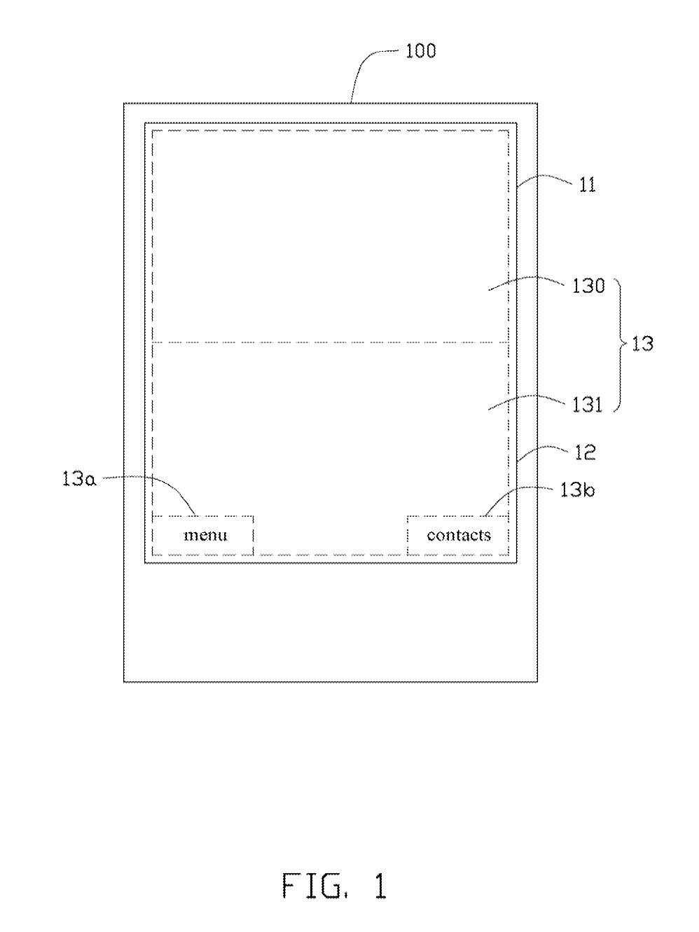

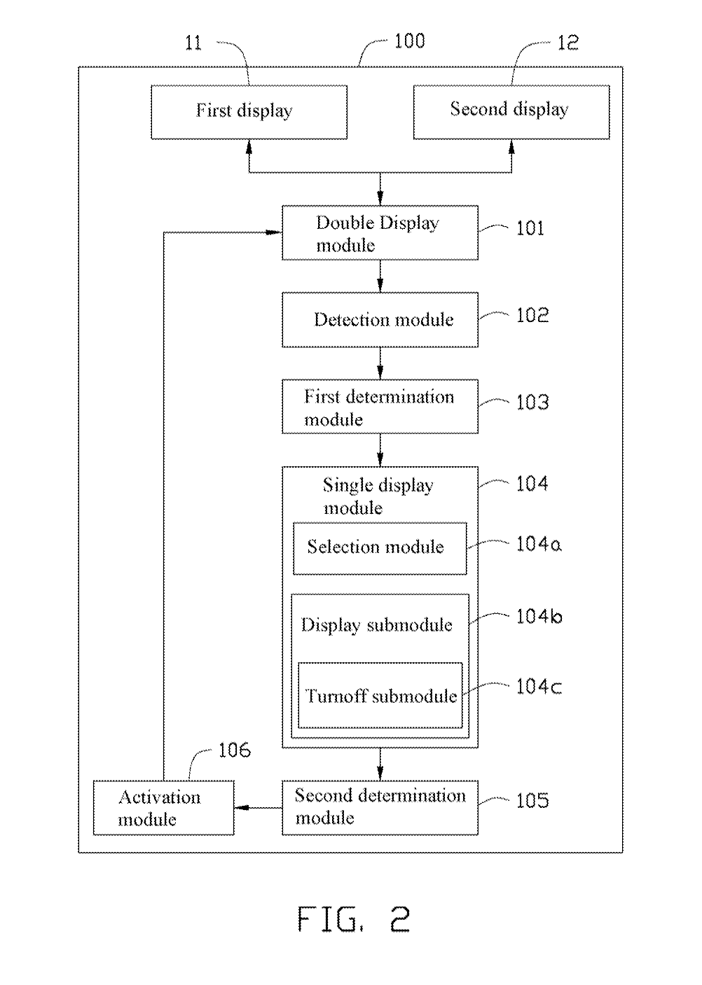

Referring to FIGS. 1-2, a double display device 100 according to an embodiment is shown. In the present embodiment, the double display device 100 is a cell phone. The double display device 100 includes a first display 11 and a second display 12. The first and the second displays 11, 12 cooperatively display an interface 13. The first display 11 displays a top half part 130 of the interface 13. The second display 12 displays a bottom half part 131 of the interface 13. The interface 13 may include a menu box 13a in the bottom left corner, and a contacts box 13b in the bottom right corner.

The double display device 100 includes a double display module 101, a detection module 102, a first determination module 103, a single display module 104, a second determination module 105, and an activation module 106. The double display device 100 further includes a battery (not shown). Hereinafter, the level of electrical charge of the double display device 100 refers to the level of electrical charge in the battery of the double display device 100, and charging the double display device 100 means charging the battery of the double display device 100.

When the double display device 100 is powered on, the double display module 101 activates the first and the second displays 11, 12. The double display module 101 splits the interface 13 into two parts, and shows the two parts on the first and the second displays 11, 12, respectively.

The detection module 102 detects the level of electrical charge in the battery of the double display device 100.

The first determination module 103 determines whether the level of electrical charge in the battery of the double display device 100 is less than or equal to a predetermined value.

If the level of electrical charge in the battery of the double display device 100 is less than or equal to the predetermined value, the single display module 104 turns off one of the first and the second displays 11, 12. The interface 13 cooperatively displayed on the first and the second displays 11, 12 is combined and then shown on either the first or the second display 11, 12. The single display module 104 includes a selection module 104a and a display submodule 104b.

The selection module 104a obtains the result of the first determination module 103. If the result indicates that the level of electrical charge in the battery of the double display device 100 is less than or equal to the predetermined value, the selection module 104a sends a dialog box, which indicates that the level of electrical charges in the battery of the double display device 100 is low. Then, queries whether the user wants to enter a single display mode or not enter the single display mode. If the user selects the single display mode, the selection module 104a activates the display submodule 104b, if the user does not select the single display mode, the double-display 100 keeps working in the double display mode.

When the user selects the single display mode, the selection module 104a activates the display submodule 104b, the display submodule 104b turns off one the first and second displays 11, 12, enables the other of the first and second displays 11, 12 to show the complete interface 13. The display submodule 104b includes a turnoff submodule 104c. The turnoff submodule 104c turns off one the first and second displays 11, 12 according to the choice of the user.

The second determination module 105 is for determining whether the double display device 100 is being charged.

The activation module 106 is for activating the double display module 101 when the double display device 100 is being charged. The activation module 106 obtains the determining result of the second determination module 105. If the double display device 100 is being charged, the activation module 106 turns on one of the first and second displays that had been turned off, so that the first and the second displays cooperatively show the interface 13.

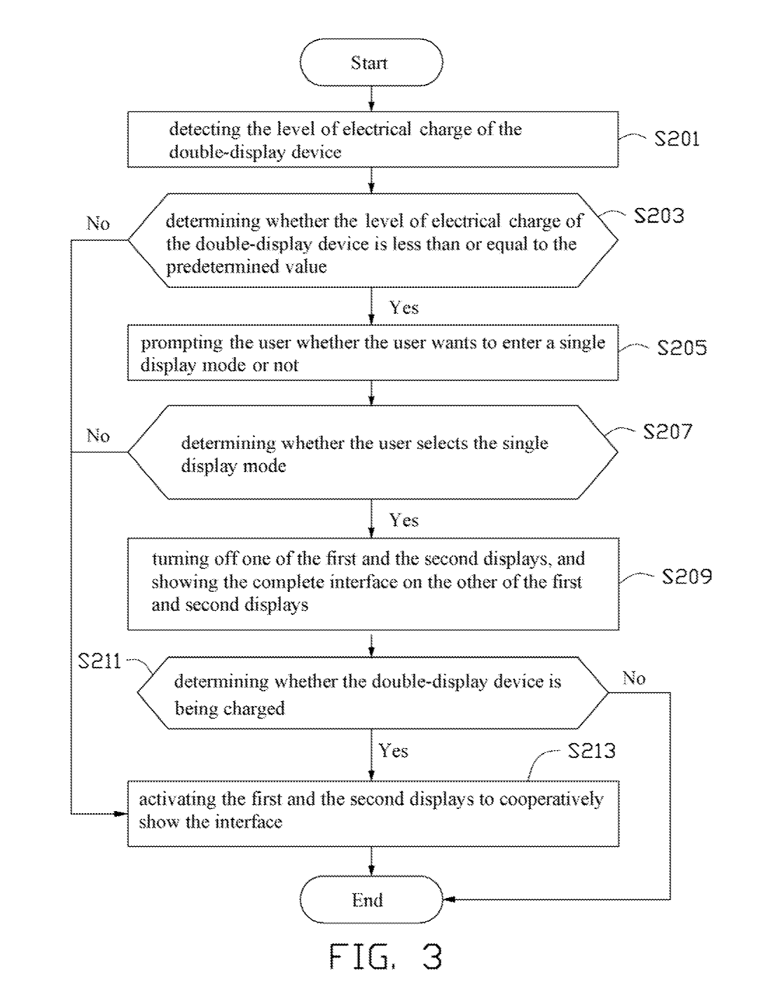

Referring to FIG. 3, a control method of the double display device 100 will be described below.

In step 201, the level of electrical charge of the double display device 100 is detected.

In step 203, it is determined that whether the level of electrical charge of the double display device 100 is less than or equal to the predetermined value. If so, control transfers to step 205. If the level of electrical charge of the double display device 100 is less than or equal to the predetermined value, then the control transfers to step 213.

In step 205, if the level of electrical charge of the double display device 100 is less than or equal to the predetermined value, the user is prompted to enter the single display mode or not.

In step 207, it is determined if the user selects the single display mode. If so, control transfers to step 209. If the user does not select the single display mode, control transfers to step S213.

In step 209, if the user chooses the single display mode, one of the first and the second displays 11, 12 is turned off, and the complete interface 13 is shown on the other of the first and second displays 11, 12.

In step 211, it is determined whether the double display device 100 is being charged. If so, control transfers to step 5213. If the double display device 100 is not being charged, control transfers to the end.

In step 213, the first and the second displays 11, 12 are activated to cooperatively show the interface 13.

While various embodiments have been described, it is to be understood that the disclosure is not limited thereto. On the contrary, various modifications and similar arrangements (as would be apparent to those skilled in the art), are also intended to be covered. Therefore, the scope of the appended claims should be accorded the broadest interpretation so as to encompass all such modifications and similar arrangements.

What is claimed is:

1. A double display device, comprising a first display and a second display, the first and the second displays cooperatively showing an interface, the double display device further comprising:
a double display module configured for activating the first and the second displays, splitting the interface into two parts, and showing the two parts on the first and the second displays respectively;
a detection module configured for detecting the level of electrical charge of the double display device;
a first determination module configured for determining whether the level of electrical charge of the double display device is less than or equal to a predetermined value; and
a single display module configured for turning off one of the first and the second displays, and displaying the interface on the other of the first and the second displays, when the level of electrical charge of the double display device is less than or equal to the predetermined value.

2. The double display device of claim 1, wherein the single display module comprises a selection module and a display submodule, the selection module is configured for detecting whether the double display device is selected to be in a single display mode, the display submodule is configured for turning off one of the first and the second displays, and displaying the interface on the other of the first and the second displays.

3. The double display device of claim 2, wherein the display submodule comprises a turnoff submodule, and the turnoff submodule is configured for turning off one of the first and the second displays.

4. The double display device of claim 1, further comprising a second determination and an activation module, wherein the second determination module is configured for determining whether the double display device is being charged, and the activation module is configured for activating the double display module when the double display device is being charged.

5. The double display device of claim 1, wherein the double display device is a cell phone.
